(19) United States
(12) Patent Application Publication
(10) Pub. No.: US 2014/0093692 A1
(43) Pub. Date: Apr. 3, 2014

(54) Resin Mold, Production Process Therefor and Uses Thereof

(71) Applicant: Soken Chemical & Engineering Co., Ltd., Tokyo (JP)

(72) Inventors: Yukihiro Miyazawa, Sayama-shi (JP); Takahide Mizawa, Sayama-shi (JP)

(73) Assignee: Soken Chemical & Engineering Co., Ltd., Tokyo (JP)

(21) Appl. No.: 14/015,090

(22) Filed: Aug. 30, 2013

(30) Foreign Application Priority Data
Sep. 28, 2012 (JP) 2012-217164
Aug. 30, 2013 (JP) 2013-178995

(51) Int. Cl. B29C 59/02; B29D 11/00

(52) U.S. Cl. CPC B29C 59/022; B29D 11/00
USPC 428/156; 425/385; 264/2.7

(57) ABSTRACT

Provided is a resin mold which is free from separation from another resin mold at the joined portions and does not impair appearance or function. Thus provided is a resin mold which is preferable for forming a large-area mold, a production process therefor, and uses thereof. The resin mold has a mold constituent to constitute one half of the resin mold having a fine depression-protrusion pattern formed on the surface by transferring, a mold constituent to constitute the other half thereof, and a connecting section between the mold constituent to constitute one half of the resin mold and the mold constituent to constitute the other half thereof, wherein the connecting section comprises an inclined plane, a production process for this resin mold, and uses of the resin mold.

### TECHNICAL FIELD

The present invention relates to a resin mold. More particularly, the present invention relates to a resin mold which is preferable for preparing a large-area mold, a production process therefor and uses thereof.

### BACKGROUND ART

Imprint technology is fine processing technology comprising pressing a mold having a reverse pattern to a desired fine depression-protrusion pattern against a transfer material such as a liquid resin on a substrate to thereby form a pattern of the mold on the transfer material. As such fine depression-protrusion patterns, nanoscale patterns on a level of 10 nm to patterns of about 100 μm are present, and they have been used in various fields, such as fields of semiconductor materials, optical materials, memory media, micromachines, biotechnology and environment.

A mold having a fine depression-protrusion pattern of nano-order on its surface is extremely expensive because formation of the pattern takes time. On that account, increase in size (increase in area) of the mold having a fine depression-protrusion pattern of nano-order on its surface is difficult.

Then, as a process for preparing a large-area mold from a small master mold, there is known, for example, a process comprising preparing plural small replica molds from a small master mold by photopolymerization or the like, placing the replica molds side by side as in tile-setting and subjecting them to multiple-plane fixing to produce a large-area mold (see, for example, patent literature 1).

If increase in area is accomplished as above, a large-size antireflection film used for, for example, a liquid crystal TV can be formed from one mold.

That is to say, as shown in FIG. 8, four replica molds 4 are prepared using a small master mold 2 (e.g., 300 mm×300 mm), then these replica molds 4 of the same shapes are arranged side by side on a base 6 made of, for example, a resin or a rubber, then gaps 10 among the replica molds 4 are filled with, for example, a photo-curing resin, and the resin is irradiated with light to form a cured layer in the gaps 10, whereby a large-area mold 18 can be prepared.

In the case of preparing the large-area mold 18 as above, however, involvement of air takes place when a photo-curing resin or the like is introduced into the gaps 10 among the small replica molds 4, as shown in an enlarged sectional view of FIG. 9. As a result, there occurs a problem that the joined portions are separated from each other later.

Moreover, after the resin introduced in the gaps 10 of the connecting sections is cured, the cured resin develops a color different from the color of their circumferences, so that there is a problem of undesirable appearance or function.

### CITATION LIST

### Patent Literature

Patent literature 1: Japanese Patent Laid-Open Publication No. 2012-118520

### SUMMARY OF INVENTION

### Technical Problem

The present invention has been made in view such circumstances as above, and it is an object of the present invention to provide a resin mold which is free from separation of the joined portions from each other and does not impair appearance or function.

It is another object of the present invention to provide a resin mold which is free from separation from another resin mold at the joined portions and does not impair appearance or function when a large-area mold is prepared from one master mold.

It is a further object of the present invention to provide a process for producing such a resin mold as above.

It is a further object of the present invention to provide uses of such a resin mold as above.

### Solution to Problem

The resin mold of the present invention to attain the above objects is a resin mold having:

a mold constituent to constitute one half of the resin mold having a fine depression-protrusion pattern formed on the surface by transferring, a mold constituent to constitute the other half thereof, and a connecting section between the mold constituent to constitute one half and the mold constituent to constitute the other half, wherein:

the connecting section comprises an inclined plane.

When the resin mold has such constitution, involvement of air rarely occurs because the resin mold does not have an integral structure formed by filling a gap with a resin.

Even in the case where a large-area mold is formed, ends of the resin molds to be connected are butted and an inclined plane is formed thereon, and therefore, separation attributable to involvement of air rarely occurs. In the case where a large-area mold is formed, further, the joining resin cured portion does not become conspicuous. Furthermore, by allowing all the connecting sections to have inclined planes in the preparation of a large-area mold, overall optical properties of the resulting large-area mold are not impaired.

In the resin mold of the present invention, the inclination angle θ of the inclined plane is desired to be usually in the range of 0°<θ≦89°, preferably 0°<θ≧75°, more preferably 0°<θ≦60°, particularly preferably 0°<θ≦45°.

When the inclined plane having such an inclination angle θ is formed, fine depressions and protrusions can be accurately transferred and favorable transfer of the pattern is possible in the case where imprinting is made on a transfer material.

The resin mold of the present invention can be produced by forming the inclined plane so that the inclination angle θ of the inclined plane may become such an angle as above.

The resin mold of the present invention can be preferably used for optical devices that are used in fields of semiconductor materials, optical materials, memory media, micromachines, biotechnology, environment, etc.

In particular, the optical device of the present invention is highly useful as an anti-reflection plate, a light diffusion plate, a contact preventing plate or the like.

### ADVANTAGEOUS EFFECTS OF INVENTION

Since the resin mold of the present invention does not have a united structure formed by filling a gap with a resin, separation attributable to involvement of air, or the like does not occur. Further, since the resin mold of the present invention does not have a structure formed by filling a gap with a resin, appearance and function are not impaired.

Furthermore, in the case where the resin mold of the present invention is arranged round a transfer roll and imprinting is made on a transfer material such as a liquid resin, there is no influence on the transfer of a pattern to the transfer material, and favorable transfer can be carried out.

Even in the case of preparing a large-area mold, involvement of air is not brought about if the resin molds to be connected are arranged so that their ends may be butted and an inclined plane may be formed thereon. As a result, separation attributable to involvement of air rarely occurs. Moreover, the resin cured portion does not become conspicuous.

By allowing the connecting section to have an inclined plane in the production of a large-size mold, the surface profile of the resulting large-area mold becomes uniform, and therefore, overall optical properties are not impaired.

### BRIEF DESCRIPTION OF DRAWINGS

FIG. 1 is a schematic perspective view schematically showing a resin mold of one example of the present invention.

FIG. 2 is a schematic sectional view taken on line A-A of FIG. 1.

FIG. 3 is a perspective view showing a state where resin molds of examples of the present invention are wound round a transfer roll to perform imprinting.

FIG. 4 is a schematic sectional view showing a state where resin molds of examples of the present invention are arranged to form a large-area mold.

FIG. 5 is a schematic sectional view showing a state where for connecting resin molds of examples of the present invention to form a large-area mold, the resin molds are arranged while providing a level difference between the resin molds.

FIG. 6 is a schematic perspective view showing a state where a large-area mold is wound round a transfer roll.

FIG. 7 is a sectional photograph of a resin mold of one example of the present invention, and is a sectional photograph corresponding to the sectional view of FIG. 2.

FIG. 8 is a group of schematic views showing one example of a conventional procedure wherein plural replica molds are prepared using a small master mold, and using these replica molds, a large-area mold is formed.

FIG. 9 is an enlarged sectional view of a butt portion of a small resin mold in the example of the conventional procedure shown in FIG. 8.

### DESCRIPTION OF EMBODIMENTS

A preferred embodiment of the present invention is described in detail hereinafter with reference to the drawings.

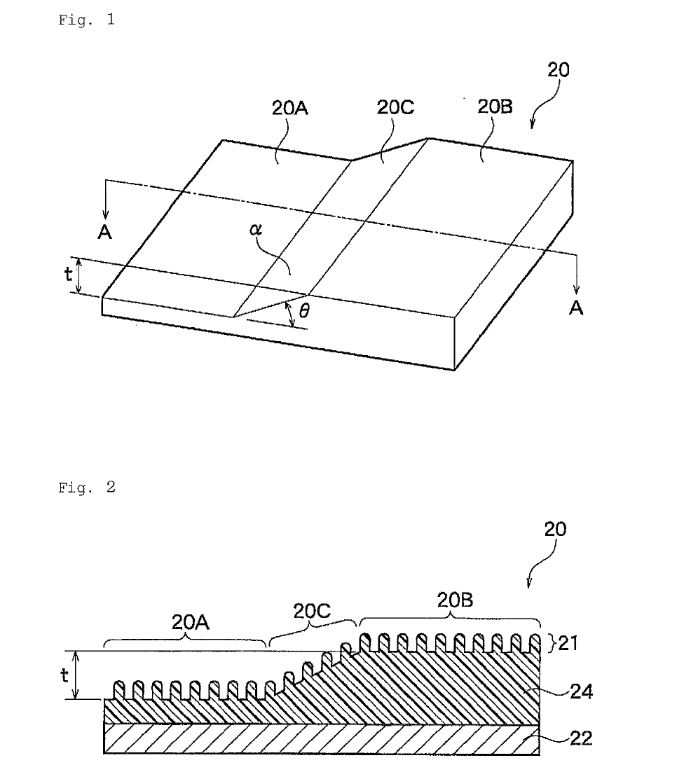

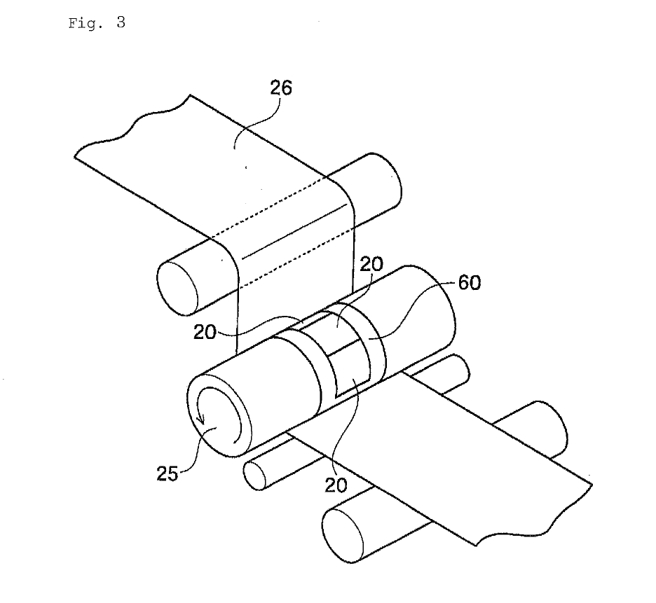

FIG. 1 is a schematic perspective view schematically showing a resin mold 20 of one example of the present invention, and FIG. 2 is a schematic sectional view taken on line A-A of FIG. 1.

On the surface of the resinmold 20, a fine depression-protrusion pattern 21 (pattern reverse to desired pattern) has been formed.

That is to say, as shown in the enlarged view of FIG. 2, this resin mold 20 has a resin layer 24 having a fine depression-protrusion pattern 21 on a substrate 22 which is made of a resin, glass, silicon or the like and is, if necessary, peeled off from the resin layer 24.

Such a resin mold 20 consists of a mold constituent 20A to constitute one half of the resin mold, a mold constituent 20B to constitute the other half thereof, and a connecting section 20C to connect these mold constituents 20A and 20B to each other.

The connecting section 20C has an inclined plane α, as shown in FIG. 1, and the inclination angle θ of the inclined plane α is usually set to not more than 89°, preferably not more than 75°, more preferably not more than 60°, particularly preferably 0°<θ45°.

When the inclination angle θ exceeds 0°, the connecting section can be made inclined, and when the inclination angle θ is not less than 0.5°, inclination of the connecting section can be readily made, so that such an inclination angle is preferable. When the inclination angle θ is usually not more than 89°, preferably not more than 75°, more preferably not more than 60°, particularly preferably not more than 45°, follow-up property to the transfer roll is good, and involvement of air does not occur, so that such inclination angles are preferable. When the inclination angle θ is not more than 30°, the height t of the ‘connecting section can be reduced, and therefore, when the resin mold is used, a uniform pressure tends to be applied by the mold constituents 20A and 20B, so that such an inclination angle is more preferable.

On the other hand, the height t of the connecting section 20C having the inclined plane α is desired to be in the range of 100 nm to 100 μm, preferably 1 μm to 20 μm. In FIG. 2, it is shown that the height t is twice or more the height of the fine depression-protrusion pattern 21, but the height t may be nearly equal to the height of the fine depression-protrusion pattern 21.

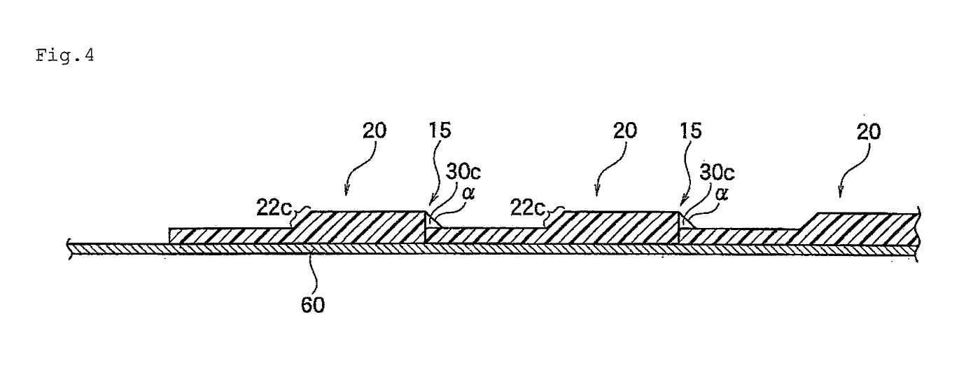

It has been confirmed that when the inclination angle θ of the inclined plane α and the height t of the connecting section 20C are set in such ranges as above, the pattern can be favorably transferred to a transfer material. That is to say, in such a case, transfer is carried out using a transfer roll 25 by the so-called roll-to-roll system, as shown in FIG. 3. In such a case, plural resin molds 20 supported on a flexible resin film 60 are wound round the transfer roll 25 first, as shown in FIG. 3. In this state, transfer to a transfer material 26 in the form of a film is carried out by the rotation of the transfer roll 25, and as a result, unexpected effect that the fine depression-protrusion pattern 21 can be favorably transferred to the transfer material 26 equally to the case of using a resin mold having a flat plane has been confirmed.

The substrate 22, which is used after it is peeled off from the resin layer 24 when needed, is one substrate selected from a resin substrate, a glass substrate, a silicon substrate, a sapphire substrate, a carbon substrate and a GaN substrate. When the substrate 22 is a resin substrate, it is preferably used in the preparation of a resin mold 20 having flexibility, and specifically, there can be mentioned a substrate made of one resin selected from the group consisting of polyethylene terephthalate, polycarbonate, polyester, polyolefin, polyimide, polysulfone, polyether sulfone, cyclic polyolefin and polyethylene naphthalate.

As the resin for forming the resin layer 24, a thermoplastic resin, a thermosetting resin or a photo-curing resin can be mentioned. Specific examples thereof include polyacrylic resin, polymethacrylic resin, polystyrene-based resin, polyolefin-based resin, polycarbonate resin, polyester-based resin and epoxy resin.

For the resin layer 24, an additive, which has a substituent capable of being bonded to a release agent arranged on the upper surface, also has a substituent having compatibility with the resin for forming the resin layer 24 and has properties (bleeding properties) of enabling uneven distribution of releasable groups onto the surface of the resin layer 24, can be used.

The additive is, for example, a compound represented by the following general formula (1) or its hydrolyzate.

Y₃₋ₙ(CH₃)ₙSiAX (1)

In the formula (1), Y is a methoxy group or an ethoxy group, A is any one of a single bond, an ethylene group and a propylene group, X is one group selected from the group consisting of an epoxy group, a glycidoxy group, a phenyl group which may have a substituent, and an amino group, and n is 0 or 1.

Here, Y or its hydrolyzed group is a group capable of being bonded to the later-described release agent, and X is a group having compatibility with the aforesaid solvent-soluble resin used for forming the resin mold.

From the viewpoint of enhancement of compatibility of the additive and the resin for forming the resin mold with each other, the resin preferably has a constituent unit having the same substituent as X in the formula (1). The constituent units having the same substituent as X are contained preferably in an amount of 1 to 15% by weight, more preferably 2 to 10% by weight, in all the constituent units of the resin for forming the resin mold. When the amount of the constituent units is in the above range, separation of the resin for forming the resin mold and the additive from each other does not occur, though bleedout of the additive onto the surface of the resin layer of the resin mold takes place.

The additive is added in an amount of 1 to 13 parts by weight, preferably 2 to 9 parts by weight, based on 100 parts by weight of the total amount of the resin for forming the resinmold and the additive.

The thickness of the resin layer is usually 50 nm to 1 mm, preferably 500 nm to 500 μm. When the resin layer has such a thickness, imprint processing is readily carried out.

Although the surface profile of the resin mold 20 (surface profile of fine depression-protrusion pattern 21) is not specifically restricted, preferable is a surface profile having a pitch of 10 nm to 2 mm, a depth of 10 nm to 100 μm, a transfer area of 1.0 to 1.0×10⁶ mm², and more preferable is a surface profile having a pitch of 20 nm to 20 μm, a depth of 50 nm to 1 μm, a transfer area of 1.0 to 0.25×10⁶ mm². The reason is that a satisfactory depression-protrusion pattern can be formed on a transfer material. Examples of the surface profiles include moth eye, line, column, monolith, circular cone, pyramid and micro lens.

The surface of the resin layer 24 having the fine depression-protrusion pattern 21 may be subjected to release treatment for preventing adhesion to a transfer body, and the release treatment may be a treatment of forming a release layer.

The release agent for forming the release layer (not shown) is preferably at least one substance selected from the group consisting of fluorine-based silane coupling agents, perfluoro compounds having amino group or carboxyl group and perfoluoroether compounds having amino group or carboxyl group, and is more preferably at least one substance selected from the group consisting of fluorine-based silane coupling agents, one-end aminated perfluoroether compounds and one-end carboxylated perfluoro(perfluoroether) compounds. These can be used as a simple substance or a composite substance.

When the above substance is used as the release agent, adhesion of the release layer to the resin layer is good, and releasability of the release layer from a resin on which imprinting is made is good.

The thickness of the release layer (not shown) is preferably 0.5 to 20 nm, more preferably 0.5 to 10 nm, most preferably 0.5 to 5 nm.

It is thought that since the group of the additive, which is unevenly distributed in the vicinity of the resin layer surface and is capable of being bonded to the release agent, is chemically bonded to the release agent, the release layer is joined to the resin layer. The chemical bonding is thought to be condensation.

It is thought that when the additive is represented by the aforesaid general formula (1), the substituent Y or its hydrolyzed group is chemically bonded to the substituent (including a group formed by hydrolysis) of the release agent.

The resin mold 20 may be produced by any process, and the production process is not specifically restricted.

For example, one mold constituent 20A and the other mold constituent 20B can be formed by publicly known imprint technology. The connecting section 20C having the inclined plane α can be formed by forming the mold constituent 20A and the mold constituent 20B separately, placing them on the resin substrate 22 at a given interval and then subjecting the gap between the mold constituents 20A and 20B to spin coating, ink jetting or the like.

As described above, even in the case of the resin mold 20 having the inclined plane α, transfer to, for example, a transfer material 26 in the form of a film, which is shown in FIG. 3, can be favorably carried out. The reason is thought to be as follows.

That is to say, in the case where transfer to the film transfer material 26 is carried out by rotation of the transfer roll 25, as shown in FIG. 3, force is greatly exerted partially on the resin mold 20.

It is thought that as a result of the above, the transfer roll 25 is rotated While force is greatly exerted partially on the resin mold 20, whereby the inclined section a is flatted and favorable transfer to the transfer material 26 is carried out.

If favorable transfer is carried out by the use of the transfer roll 25 as above, favorable transfer can be also carried out even in the case of a large-size (large-area) resin mold obtained by arranging a large number of these resin molds 20. Actually, favorable transfer could be carried out. That is to say, it has been confirmed that the resin mold 20 having the inclined plane α has a basic shape suitable for forming a large-size mold.

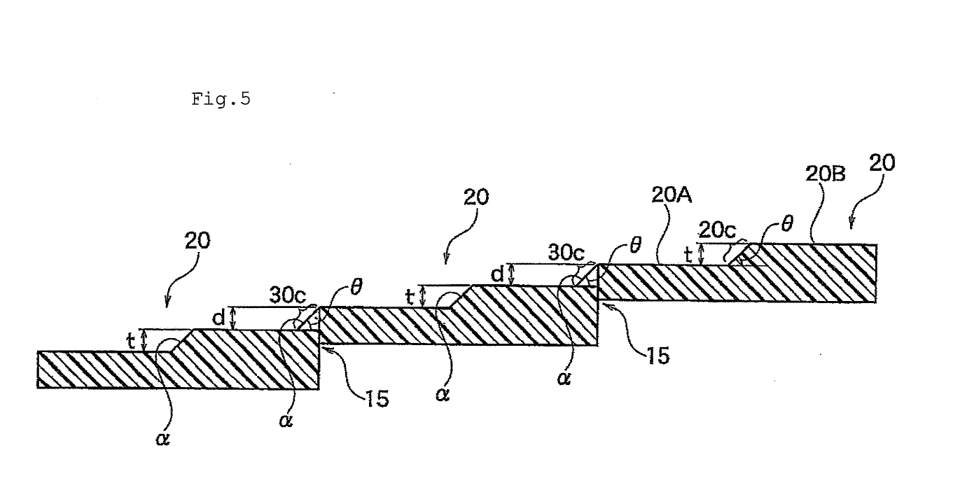

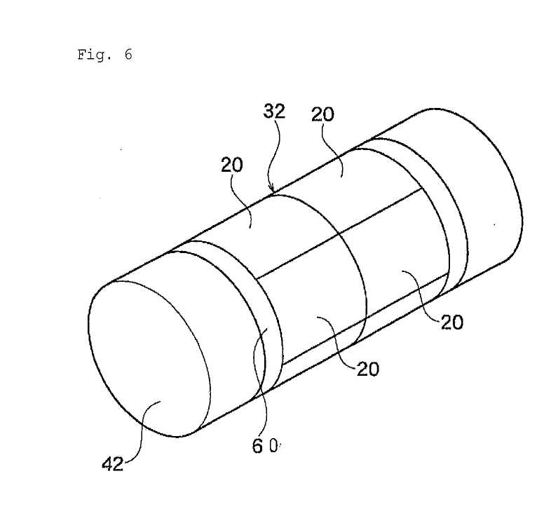

When a large-area mold is prepared using small resin molds 20 as above, the preparation process is carried out as shown in, for example, FIG. 4 or FIG. 5.

FIG. 4 shows an example of arrangement in which plural resin molds 20 are arranged planarly on the upper surface of, for example, a resin film 60.

In the case of FIG. 4, plural resin molds 20 are arranged in the same direction while butting the ends of the resin molds on the resin film 60, and at the butt portion 15, a connecting section 30C having an inclined plane α is formed, similarly to the case of the connecting section 20C shown in FIG. 1.

In FIG. 4, plural resin molds 20 are arranged side by side in the lengthwise direction of the resin film 60, but the resin molds may be arranged in the crosswise direction in combination, and at the butt portion 15, a connecting section 30C having an inclined plane α may be formed, similarly to the case of the connecting section 20C shown in FIG. 1.

Thus, a large-area mold can be formed from the small-size resin molds 20. There is no limitation on the means to fix the resin molds 20 to the resin film 60.

The method for forming the connecting section 30C is not specifically restricted, but for example, it can be formed by spin coating or the like. When the connecting section 30C having the inclined plane α is formed by spin coating or the like, involvement of air rarely occurs. Further, the connecting section 30C of a triangular cross-sectional shape extends over the ends of the molds on both sides, and therefore, separation of the resin molds from each other, or the like does not take place. Furthermore, when the resin cured portion is visually observed from above, that portion does not become conspicuous.

On the other hand, a large-area mold can be also formed as shown in FIG. 5.

In the case of FIG. 5, an example in which a level difference having a height d is provided between the resin molds 20 and 20 is shown.

The height d is preferably the same as the height t of the inclined plane 20 of the connecting section 20C (t=d). That is to say, the shape of the connecting section 20C of the small resin mold 20 is preferably the same as the shape of the connecting section 30C formed when the small resin molds 20 are connected. By forming the connecting section 300 in this manner, overall optical properties can be made uniform even in the case of a large-area mold.

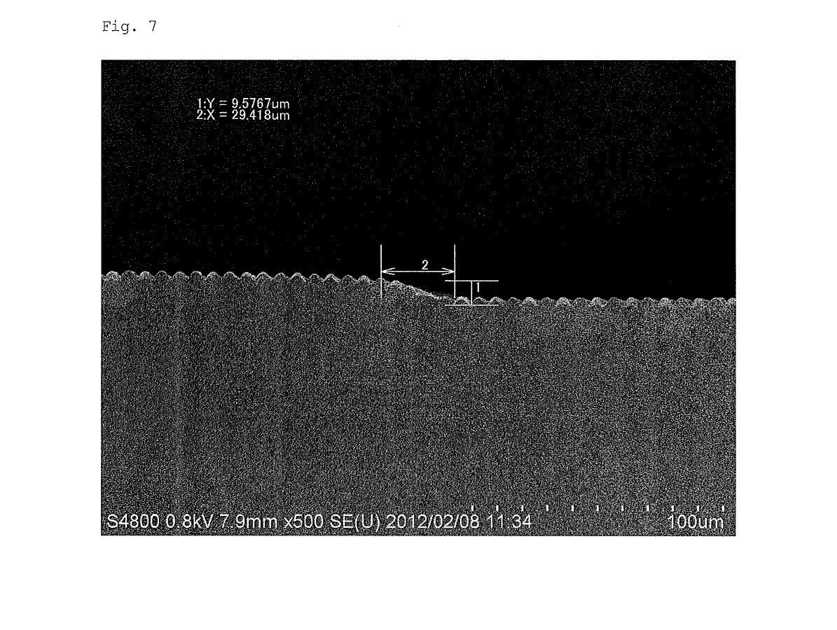

A resin mold having been made to have a large area as shown in FIG. 5 is wound round a transfer roll 42 shown in FIG. 6, and in this state, transfer to the film transfer material 26 is carried out as shown in FIG. 3, whereby a mold of a large area can be formed.

Accordingly, by carrying out imprinting using a resinmold having been made to have a large area as shown in FIG. 4 or FIG. 5, a large-size optical device (anti-reflection plate, light diffusion plate, contact preventing plate or the like) having a fine depression-protrusion pattern formed thereon is obtained. The present inventor has succeeded in preparing a large-area resin mold having a maximum length of 850 mm and a maximum width of 600 mm from a mold of 20 mm square.

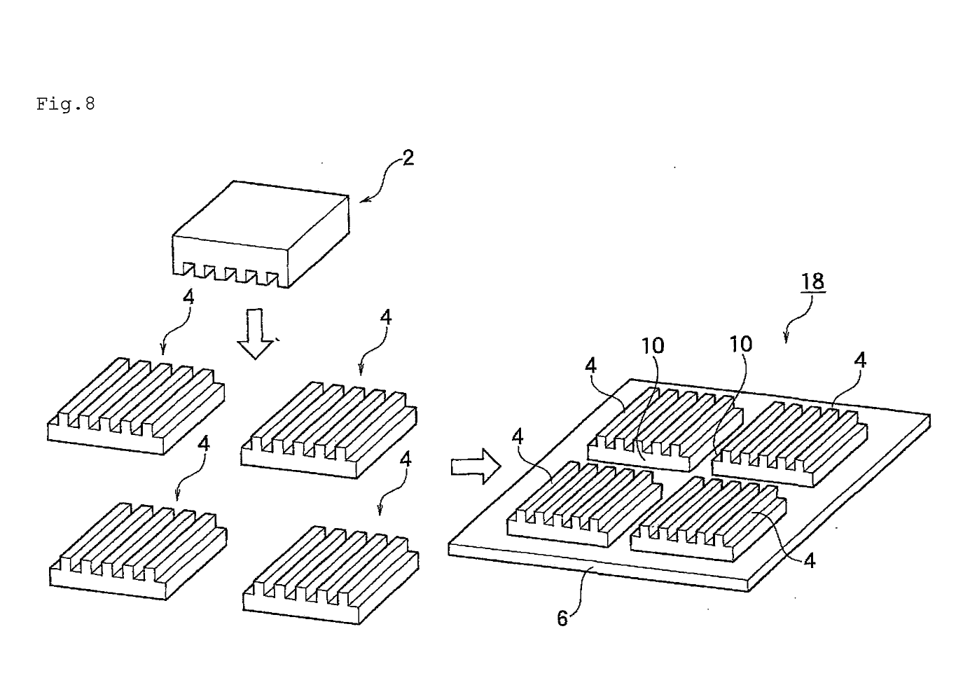

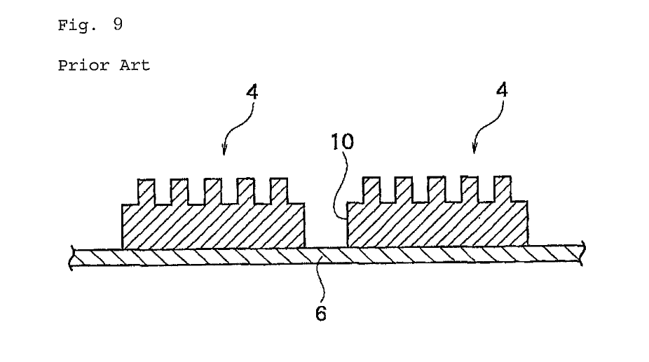

FIG. 7 is a sectional photograph of a resin mold having been made to have a large area, taken by a scanning electron microscope, and this photograph corresponds to the sectional view of FIG. 2. In this sectional photograph, at the connecting section 20C between the mold constituent 20A to constitute one half and the mold constituent 20B to constitute the other half, a gentle level difference is formed, and an inclined plane α of the connecting section 20C can be confirmed. The fine depression-protrusion pattern of the resin mold 20 photographed in FIG. 7 has a depth of 5.5 μm and a pitch of 7.6 μm. Since the height t of this connecting section 20C is 9.5767 μm and the length of the bottom of the section to constitute the inclined plane is 29.418 μm, the inclination angle θ of the inclined plane is about 18.0°.

### REFERENCE SIGNS LIST

6: base

15: butt portion

18: large-area mold

20: resin mold

20A: mold constituent on one side

20B: mold constituent on the other side

20C: connecting section

21: fine depression-protrusion pattern

22: substrate

24: resin layer

25: transfer roll

26: transfer material

30C: connecting section

32: mold of large area

60: resin film

θ: inclination angle of inclined plane

d: height of level difference

t: height of inclined plane

1. A resin mold having:
a mold constituent on one side of the resin mold having a fine depression-protrusion pattern formed on the surface by transferring, a mold constituent on the other side thereof, and a connecting section between the mold constituent on one side and the mold constituent on the other side, wherein:
the connecting section comprises an inclined plane.

2. The resin mold as claimed in claim 1, wherein the inclination angle θ of the inclined plane is in the range of 0°<θ≦89°.

3. The resin mold as claimed in claim 1, wherein the inclination angle θ of the inclined plane is in the range of 0°<θ≦75°.

4. The resin mold as claimed in claim 1, wherein the inclination angle θ of the inclined plane is in the range of 0°<θ≦60°.

5. The resin mold as claimed in claim 1, wherein the inclination angle θ of the inclined plane is in the range of 0°<θ≦45°.

6. A production process for an optical device, comprising carrying out imprinting using the resin mold as claimed in claim 1.

7. An optical device obtained by carrying out imprinting using the resin mold as claimed in claim 1.

8. The optical device as claimed in claim 7, which is any one device selected from the group consisting of an anti-reflection plate, a light diffusion plate and a contact preventing plate.

9. A production process for an optical device, comprising carrying out imprinting using the resin mold as claimed in claim 2.

10. A production process for an optical device, comprising carrying out imprinting using the resin mold as claimed in claim 3.

11. A production process for an optical device, comprising carrying out imprinting using the resin mold as claimed in claim 4.

12. A production process for an optical device, comprising carrying out imprinting using the resin mold as claimed in claim 5.

13. An optical device obtained by carrying out imprinting using the resin mold as claimed in claim 2.

14. An optical device obtained by carrying out imprinting using the resin mold as claimed in claim 3.

15. An optical device obtained by carrying out imprinting using the resin mold as claimed in claim 4.

16. An optical device obtained by carrying out imprinting using the resin mold as claimed in claim 5.

17. The optical device as claimed in claim 13, which is any one device selected from the group consisting of an anti-reflection plate, a light diffusion plate and a contact preventing plate.

18. The optical device as claimed in claim 14, which is any one device selected from the group consisting of an anti-reflection plate, a light diffusion plate and a contact preventing plate.

19. The optical device as claimed in claim 15, which is any one device selected from the group consisting of an anti-reflection plate, a light diffusion plate and a contact preventing plate.

20. The optical device as claimed in claim 16, which is any one device selected from the group consisting of an anti-reflection plate, a light diffusion plate and a contact preventing plate.
